(19) United States
(12) Patent Application Publication
(10) Pub. No.: US 2017/0246854 A1
(43) Pub. Date: Aug. 31, 2017

(54) MAGNETIC MEDIA HOLDER FOR PRINTER

(71) Applicant: Intermec Technologies Corporation, Fort Mill, SC (US)

(72) Inventors: Wai Kit Ho, Singapore (SG); Harry Nicholas Makabali Lansangan, Singapore (SG); Ling Siong Chwa, Singapore (SG)

(21) Appl. No.: 15/592,413

(22) Filed: May 11, 2017

Related U.S. Application Data
(63) Continuation of application No. 14/881,458, filed on Oct. 13, 2015, now Pat. No. 9,656,487.

(51) Int. Cl. B41F 21/04

(52) U.S. Cl. CPC B41F 21/04

(57) ABSTRACT

A print media holder device has first and second grip members. Permanent magnets are attached to the first and second grip members. An electromagnet is disposed between the first and second grip members, where when the electromagnet is selectively energized the permanent magnets attached to the first and second grip members are repelled in a manner that increases the outer dimension of the print media holder device to grip a media core.

### CROSS-REFERENCE TO RELATED APPLICATION

The present application claims the benefit of U.S. patent application Ser. No. 14/881,458 for a Magnetic Media Holder for Printer filed Oct. 13, 2015 (and published Apr. 13, 2017 as U.S. Patent Publication No. 2017/0100945), now U.S. Pat. No. 9,656,487. Each of the foregoing patent application, patent publication, and patent is hereby incorporated by reference in its entirety.

### FIELD OF THE INVENTION

The present invention relates to printers and a mechanism for holding rolls of print media.

### BACKGROUND

Generally speaking, industry and desktop printers are often equipped with a media holder to position a roll of print media into a desirable position. Certain printers are often equipped with a rotational media holder to achieve high precision printing. A rotational holder conventionally utilizes a frictionally gripping system to hold onto an internal core of a media roll. However, many users are facing issues with such systems due to wide variation in the core size for media from different suppliers. The result is that often a high level of insertion force is required for cores of smaller diameter and insufficient gripping force is encountered for larger diameter cores. This can affect printing performance and may require a change in media supplier.

Therefore, a need exists for an improved gripping mechanism for holding roll media for a printer.

### SUMMARY

Accordingly, in one aspect, the present invention embraces an improved gripping mechanism for holding roll media for a printer.

In an exemplary embodiment, a print media holder device has a first grip member and at least one permanent magnet attached to the first grip member. A second grip member has at least one permanent magnet attached to the second grip member. The print media holder device has an outer dimension that is defined as a distance from an outermost portion of the first grip member to an outermost portion of the second grip member. An electromagnet is disposed between the first and second grip members, where when the electromagnet is selectively energized the permanent magnets attached to the first and second grip members are repelled in a manner that increases the outer dimension of the print media holder device to grip a media core.

In certain implementations, the first grip member terminates at an outermost point with one or more grip edges that are configured to grip the media core. In certain implementations, the second grip member terminates at an outermost point with one or more grip edges that are configured to grip the media core. In certain implementations, the electromagnet is selectively energized with a specified current to establish a specified repelling force. In certain implementations, the print media holder device resides within a printer.

In another exemplary embodiment, a print media holder device has a first grip member having a first grip edge with a first grip member magnet attached to the first grip member. A second grip member has a second grip edge. The print media holder device has an outer dimension that is defined as a distance from an outermost portion of the first grip member's grip edge to an outermost portion of the second grip member's grip edge. A second magnet is disposed between the first and second grip edge. At least one of the second magnet and the grip member magnet comprises an electromagnet that is selectively energized in a manner that generates repelling forces between the grip member magnet and the second magnet such that the first and second grip edges pushed outward by magnetic force in a manner that increases the outer dimension of the print media holder device to grip a media core.

In certain example implementations, first grip member magnet comprises a permanent magnet and where the second magnet comprises an electromagnet. In certain example implementations, the first grip member magnet comprises an electromagnet and where the second magnet comprises a permanent magnet. In certain example implementations, a second grip member magnet is attached to the second grip member. In certain example implementations, the first and second grip member magnets comprise a permanent magnet and where the second magnet comprises an electromagnet. In certain example implementations, the first and second grip member magnets comprise an electromagnet and where the second magnet comprises a permanent magnet. In certain example implementations, the electromagnet is selectively energized with a specified current to establish a specified repelling force. In certain example implementations, the print media holder device resides within a printer.

In yet another exemplary embodiment, a print media holder device has a plurality of grip members, each having a grip edge and a plurality of grip member magnets, each attached to one of the grip member. The print media holder device has an outer diameter that is defined as distance from an outermost portion of the first grip member edges. A plurality of central magnets is disposed at a central location with respect to the plurality of grip members. The at least one of the central magnets and the grip member magnets include an electromagnet that is selectively energized in a manner that generates repelling forces between the grip member magnets and the central magnets such that the grip edges are pushed outward by magnetic force in a manner that increases the outer diameter of the print media holder device to grip a media core.

In certain embodiments, the grip member magnets comprise permanent magnets and where the central magnets comprise electromagnets.

In certain embodiments, the grip member magnets comprise electromagnets and where the central magnets comprise permanent magnets. In certain embodiments, the electromagnet is selectively energized with a specified current to establish a specified repelling force. In certain embodiments, the print media holder device resides within a printer.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 depicts an example embodiment of a media holder device consistent with the present invention.

FIG. 2 further depicts the example embodiment of the media holder device with media engaged in a manner consistent with the present invention.

FIG. 3 further depicts the example embodiment of the media holder device with media disengaged in a manner consistent with the present invention.

### DETAILED DESCRIPTION

The present invention, in certain implementations, provides a mechanism for gripping a media core for a printer.

A magnetic media holder device consistent with the present teachings provides for improved adaptation to variations in media core size for rolled print media over that of more conventional media core gripping techniques used within printers. This magnetic core gripping device utilizes magnetism to control and adjust the gripping force that is used to hold the media core over a wide range of sizes and can improve the printer performance.

At the same time, the present core gripping system can automatically reduce the gripping force to facilitate easy loading/unloading of the media at a very low insertion/removing force during media loading/unloading to improve the user experience.

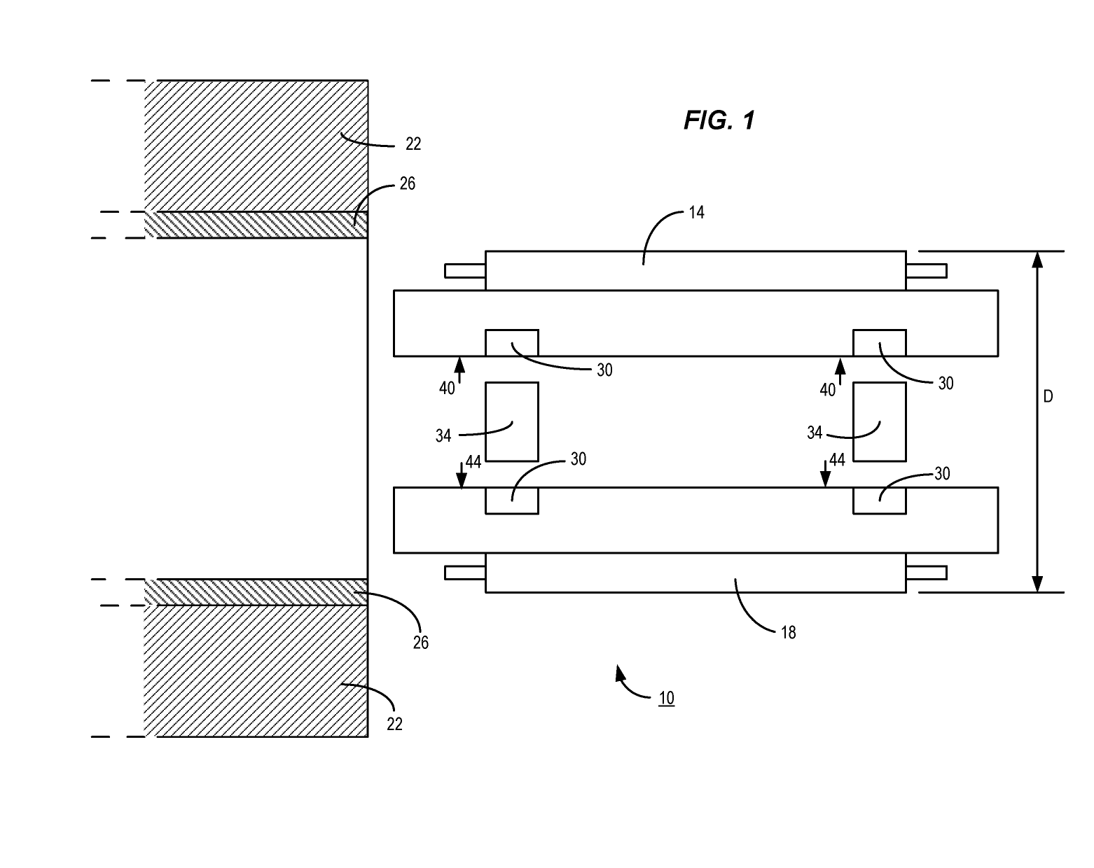

Referring to FIG. 1, a magnetic holding system 10 as it resides within a printing device (printer) includes a pair of core moveable grip members 14 and 18 (e.g., grip members which terminate at the outermost point with one or more gripping edges that grab the interior of a media core at the center of a roll of print media such as paper) which ultimately engage the interior of a roll of print media 22 at a core 26 (shown in cross-section). The media holder 10 includes one or more permanent magnets 30 in the movable grip members. Additionally, one or more electromagnets 34 are positioned between the moveable grip members to generate repulsion forces that repel the permanent magnets so as to mechanically engage the media core 26 when the electromagnets are engaged. The electromagnets serve as control magnets that control the position of the grip members 14 and 18.

The magnetic energizing of the electromagnets can be controlled by a processor or a simple switching mechanism (not shown) which selectively engages the electromagnets with an appropriate strength and polarity to generate repulsive or attractive forces with respect to the permanent magnets. The repulsive forces may be automatically adjusted using current provided by the printer system to the electromagnets to maintain contact with the inner side of the media core based upon the size of the inner diameter of the media core 26. In this manner the dimension D of the media holder device can be adjusted. The print media holder device has an outer dimension D that is defined as distance from an outermost portion of the first grip member 14 to an outermost portion of the second grip member 18 as shown. When the electromagnet is energized to engage the media core 26, the dimension D increases until the core 26 is contacted and engaged.

In order to accomplish engagement with core 26, the electromagnets 34 are energized so as to create electromagnetic force having a polarity with respect to magnets 30 that cause the grip members 14 and 18 to be pushed away from the electromagnets 34 in the direction shown by arrows 40 and 44 (away from the electromagnets). When the holder 10 is to be inserted into a new media core, the electromagnetic force from 34 can be removed to allow the grip members 14 and 18 to freely accept the new core 26. In another variation, the polarity of the electromagnets can be reversed to create an attractive force between magnets 30 and electromagnets 34 to produce forces in the opposite direction as that shown by arrows 40 and 44 so as to cause the grip members 14 and 18 to be attracted by the electromagnets 34 and assume a smaller outer dimension that will easily pass within a core 26 of the smallest anticipated size. Thus, in essence, the outer diameter of the holder 10 is adjusted by use of electromagnetic forces from selectively actuated electromagnets 34 which selectively push the grip members 14 and 18 outward to increase the holder's diameter so as to appropriately grip a variety of sizes of media cores.

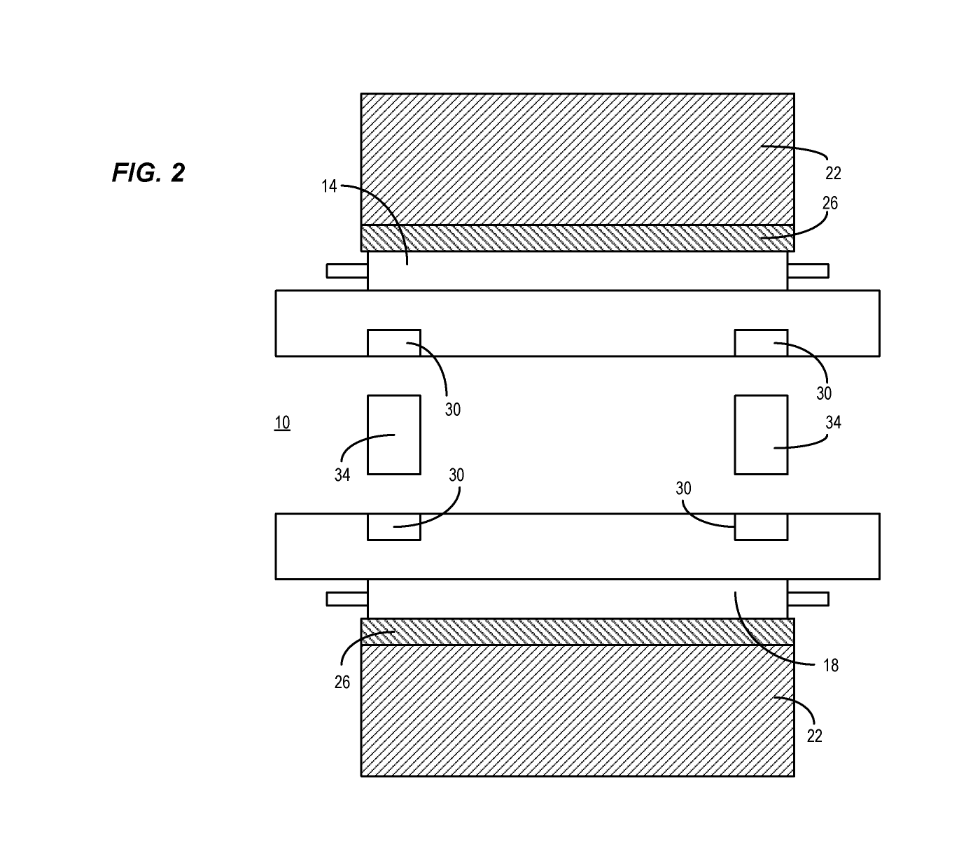

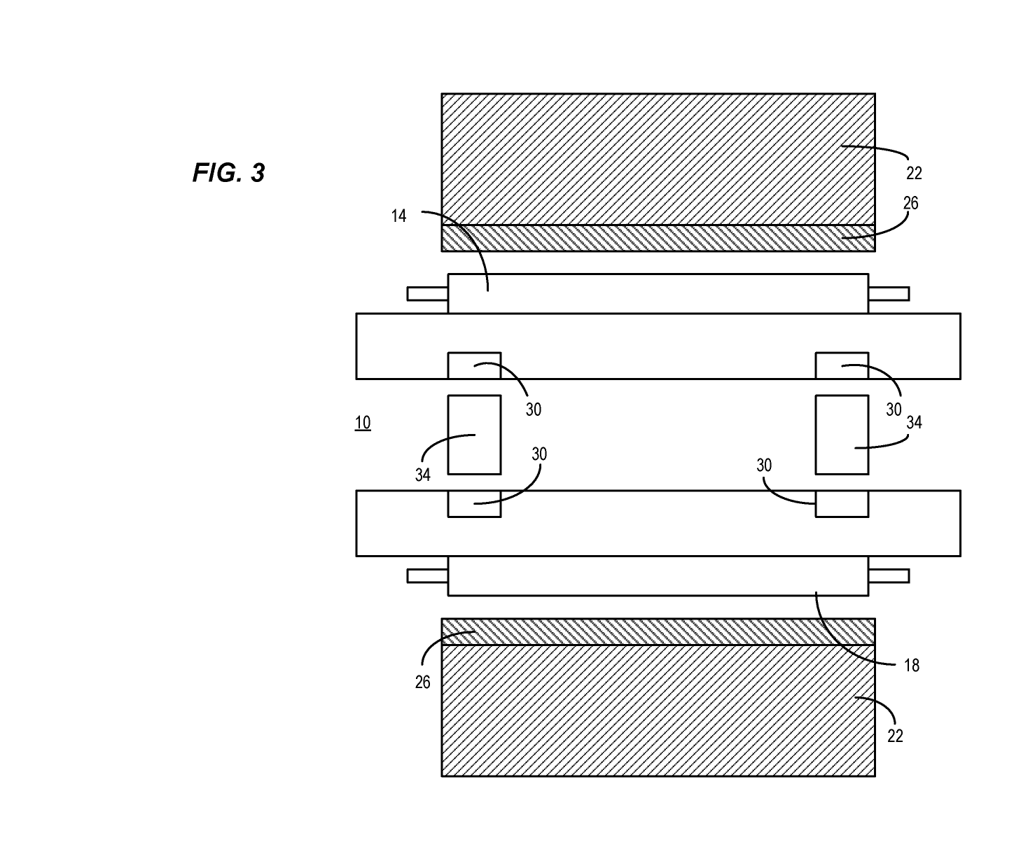

Referring to FIG. 2, the same media holder device 10 is depicted with the grip members 14 and 18 engaging the inner surface of the core 26. FIG. 3 shows the same media holder device 10 with the grip members 14 and 18 disengaged from the inner surface of core 26 to allow for easy loading and unloading of media.

Thus, a print media holder device consistent with these teachings has a first grip member having a first grip edge. A first grip member magnet is attached to the first grip member. A second grip member has a second grip edge. The print media holder device has an outer dimension that is defined as a distance from an outermost portion of the first grip member's grip edge to an outermost portion of the second grip member's grip edge. A second magnet is disposed between the first and second grip edges. At least one of the second magnet and the grip member magnet is an electromagnet that is selectively energized in a manner that generates repelling forces between the grip member magnet and the second magnet such that the first and second grip edges pushed outward by magnetic force in a manner that increases the outer dimension of the print media holder device to grip a media core.

In this example, the first grip member magnet can be a permanent magnet and where the second magnet can be an electromagnet. Or, the first grip member magnet can be an electromagnet and the second magnet can be a permanent magnet. The electromagnet can be selectively energized with a specified current to establish a specified repelling force. The print media holder device resides within a printer so as to carry the print media consumed by the printer.

Many variations will occur to those skilled in the art upon consideration of the present teachings. For example, while the embodiment shown in FIGS. 1-3 depict an example having two electromagnets 34 and four permanent magnets 30 using a pair of grip members 14 and 18, this should not be considered limiting. A single electromagnet 34 could be used in conjunction with multiple or single permanent magnets 30 on each of the grip members 14 and 18. Additionally, more than two electromagnets paired with more than four permanent magnets could also be used without limitation. Further, although two grip members 14 and 18 are shown and described, there is no reason why more than two moveable holder members cannot be utilized. Furthermore, a single stationary grip member could be used in conjunction with a single moveable grip member without limitation. Additionally, while the electromagnets 34 are shown at the center and permanent magnets attached to the holder members, their relative positions could be reversed with the permanent magnets being situated centrally and the electromagnets carried by the holder members. The electromagnet can be selectively energized with a specified current to establish a specified repelling force that is suitable to gripping a variety of media cores. Many other variations will occur to those skilled in the art upon consideration of the present teachings.

To supplement the present disclosure, this application incorporates entirely by reference the following commonly assigned patents, patent application publications, and patent applications:

U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;

### International Publication No. 2013/163789;

### International Publication No. 2013/173985;

### International Publication No. 2014/019130;

### International Publication No. 2014/110495;

### U.S. Patent Application Publication No. 2008/0185432;

### U.S. Patent Application Publication No. 2009/0134221;

### U.S. Patent Application Publication No. 2010/0177080;

### U.S. Patent Application Publication No. 2010/0177076;

### U.S. Patent Application Publication No. 2010/0177707;

### U.S. Patent Application Publication No. 2010/0177749;

### U.S. Patent Application Publication No. 2010/0265880;

### U.S. Patent Application Publication No. 2011/0202554;

### U.S. Patent Application Publication No. 2012/0111946;

### U.S. Patent Application Publication No. 2012/0168511;

### U.S. Patent Application Publication No. 2012/0168512;

### U.S. Patent Application Publication No. 2012/0193423;

### U.S. Patent Application Publication No. 2012/0203647;

### U.S. Patent Application Publication No. 2012/0223141;

### U.S. Patent Application Publication No. 2012/0228382;

### U.S. Patent Application Publication No. 2012/0248188;

### U.S. Patent Application Publication No. 2013/0043312;

### U.S. Patent Application Publication No. 2013/0082104;

### U.S. Patent Application Publication No. 2013/0175341;

### U.S. Patent Application Publication No. 2013/0175343;

### U.S. Patent Application Publication No. 2013/0257744;

### U.S. Patent Application Publication No. 2013/0257759;

### U.S. Patent Application Publication No. 2013/0270346;

### U.S. Patent Application Publication No. 2013/0287258;

### U.S. Patent Application Publication No. 2013/0292475;

### U.S. Patent Application Publication No. 2013/0292477;

### U.S. Patent Application Publication No. 2013/0293539;

### U.S. Patent Application Publication No. 2013/0293540;

### U.S. Patent Application Publication No. 2013/0306728;

### U.S. Patent Application Publication No. 2013/0306731;

### U.S. Patent Application Publication No. 2013/0307964;

### U.S. Patent Application Publication No. 2013/0308625;

### U.S. Patent Application Publication No. 2013/0313324;

### U.S. Patent Application Publication No. 2013/0313325;

### U.S. Patent Application Publication No. 2013/0342717;

### U.S. Patent Application Publication No. 2014/0001267;

### U.S. Patent Application Publication No. 2014/0008439;

### U.S. Patent Application Publication No. 2014/0025584;

### U.S. Patent Application Publication No. 2014/0034734;

### U.S. Patent Application Publication No. 2014/0036848;

### U.S. Patent Application Publication No. 2014/0039693;

### U.S. Patent Application Publication No. 2014/0042814;

### U.S. Patent Application Publication No. 2014/0049120;

### U.S. Patent Application Publication No. 2014/0049635;

### U.S. Patent Application Publication No. 2014/0061306;

### U.S. Patent Application Publication No. 2014/0063289;

### U.S. Patent Application Publication No. 2014/0066136;

### U.S. Patent Application Publication No. 2014/0067692;

### U.S. Patent Application Publication No. 2014/0070005;

### U.S. Patent Application Publication No. 2014/0071840;

### U.S. Patent Application Publication No. 2014/0074746;

### U.S. Patent Application Publication No. 2014/0076974;

### U.S. Patent Application Publication No. 2014/0078341;

### U.S. Patent Application Publication No. 2014/0078345;

### U.S. Patent Application Publication No. 2014/0097249;

### U.S. Patent Application Publication No. 2014/0098792;

### U.S. Patent Application Publication No. 2014/0100813;

### U.S. Patent Application Publication No. 2014/0103115;

### U.S. Patent Application Publication No. 2014/0104413;

### U.S. Patent Application Publication No. 2014/0104414;

### U.S. Patent Application Publication No. 2014/0104416;

### U.S. Patent Application Publication No. 2014/0104451;

### U.S. Patent Application Publication No. 2014/0106594;

### U.S. Patent Application Publication No. 2014/0106725;

### U.S. Patent Application Publication No. 2014/0108010;

### U.S. Patent Application Publication No. 2014/0108402;

### U.S. Patent Application Publication No. 2014/0110485;

### U.S. Patent Application Publication No. 2014/0114530;

### U.S. Patent Application Publication No. 2014/0124577;

### U.S. Patent Application Publication No. 2014/0124579;

### U.S. Patent Application Publication No. 2014/0125842;

### U.S. Patent Application Publication No. 2014/0125853;

### U.S. Patent Application Publication No. 2014/0125999;

### U.S. Patent Application Publication No. 2014/0129378;

### U.S. Patent Application Publication No. 2014/0131438;

### U.S. Patent Application Publication No. 2014/0131441;

### U.S. Patent Application Publication No. 2014/0131443;

### U.S. Patent Application Publication No. 2014/0131444;

### U.S. Patent Application Publication No. 2014/0131445;

### U.S. Patent Application Publication No. 2014/0131448;

### U.S. Patent Application Publication No. 2014/0133379;

### U.S. Patent Application Publication No. 2014/0136208;

### U.S. Patent Application Publication No. 2014/0140585;

### U.S. Patent Application Publication No. 2014/0151453;

### U.S. Patent Application Publication No. 2014/0152882;

### U.S. Patent Application Publication No. 2014/0158770;

### U.S. Patent Application Publication No. 2014/0159869;

### U.S. Patent Application Publication No. 2014/0166755;

### U.S. Patent Application Publication No. 2014/0166759;

### U.S. Patent Application Publication No. 2014/0168787;

### U.S. Patent Application Publication No. 2014/0175165;

### U.S. Patent Application Publication No. 2014/0175172;

### U.S. Patent Application Publication No. 2014/0191644;

### U.S. Patent Application Publication No. 2014/0191913;

### U.S. Patent Application Publication No. 2014/0197238;

### U.S. Patent Application Publication No. 2014/0197239;

### U.S. Patent Application Publication No. 2014/0197304;

### U.S. Patent Application Publication No. 2014/0214631;

### U.S. Patent Application Publication No. 2014/0217166;

### U.S. Patent Application Publication No. 2014/0217180;

### U.S. Patent Application Publication No. 2014/0231500;

### U.S. Patent Application Publication No. 2014/0232930;

### U.S. Patent Application Publication No. 2014/0247315;

### U.S. Patent Application Publication No. 2014/0263493;

### U.S. Patent Application Publication No. 2014/0263645;

### U.S. Patent Application Publication No. 2014/0267609;

### U.S. Patent Application Publication No. 2014/0270196;

### U.S. Patent Application Publication No. 2014/0270229;

### U.S. Patent Application Publication No. 2014/0278387;

### U.S. Patent Application Publication No. 2014/0278391;

### U.S. Patent Application Publication No. 2014/0282210;

### U.S. Patent Application Publication No. 2014/0284384;

### U.S. Patent Application Publication No. 2014/0288933;

### U.S. Patent Application Publication No. 2014/0297058;

### U.S. Patent Application Publication No. 2014/0299665;

### U.S. Patent Application Publication No. 2014/0312121;

### U.S. Patent Application Publication No. 2014/0319220;

### U.S. Patent Application Publication No. 2014/0319221;

### U.S. Patent Application Publication No. 2014/0326787;

### U.S. Patent Application Publication No. 2014/0332590;

### U.S. Patent Application Publication No. 2014/0344943;

### U.S. Patent Application Publication No. 2014/0346233;

### U.S. Patent Application Publication No. 2014/0351317;

### U.S. Patent Application Publication No. 2014/0353373;

### U.S. Patent Application Publication No. 2014/0361073;

### U.S. Patent Application Publication No. 2014/0361082;

### U.S. Patent Application Publication No. 2014/0362184;

### U.S. Patent Application Publication No. 2014/0363015;

### U.S. Patent Application Publication No. 2014/0369511;

### U.S. Patent Application Publication No. 2014/0374483;

### U.S. Patent Application Publication No. 2014/0374485;

### U.S. Patent Application Publication No. 2015/0001301;

### U.S. Patent Application Publication No. 2015/0001304;

### U.S. Patent Application Publication No. 2015/0003673;

### U.S. Patent Application Publication No. 2015/0009338;

### U.S. Patent Application Publication No. 2015/0009610;

### U.S. Patent Application Publication No. 2015/0014416;

### U.S. Patent Application Publication No. 2015/0021397;

### U.S. Patent Application Publication No. 2015/0028102;

### U.S. Patent Application Publication No. 2015/0028103;

### U.S. Patent Application Publication No. 2015/0028104;

### U.S. Patent Application Publication No. 2015/0029002;

### U.S. Patent Application Publication No. 2015/0032709;

### U.S. Patent Application Publication No. 2015/0039309;

### U.S. Patent Application Publication No. 2015/0039878;

### U.S. Patent Application Publication No. 2015/0040378;

### U.S. Patent Application Publication No. 2015/0048168;

### U.S. Patent Application Publication No. 2015/0049347;

### U.S. Patent Application Publication No. 2015/0051992;

### U.S. Patent Application Publication No. 2015/0053766;

### U.S. Patent Application Publication No. 2015/0053768;

### U.S. Patent Application Publication No. 2015/0053769;

### U.S. Patent Application Publication No. 2015/0060544;

### U.S. Patent Application Publication No. 2015/0062366;

### U.S. Patent Application Publication No. 2015/0063215;

### U.S. Patent Application Publication No. 2015/0063676;

### U.S. Patent Application Publication No. 2015/0069130;

### U.S. Patent Application Publication No. 2015/0071819;

### U.S. Patent Application Publication No. 2015/0083800;

### U.S. Patent Application Publication No. 2015/0086114;

### U.S. Patent Application Publication No. 2015/0088522;

### U.S. Patent Application Publication No. 2015/0096872;

### U.S. Patent Application Publication No. 2015/0099557;

### U.S. Patent Application Publication No. 2015/0100196;

### U.S. Patent Application Publication No. 2015/0102109;

### U.S. Patent Application Publication No. 2015/0115035;

### U.S. Patent Application Publication No. 2015/0127791;

### U.S. Patent Application Publication No. 2015/0128116;

### U.S. Patent Application Publication No. 2015/0129659;

### U.S. Patent Application Publication No. 2015/0133047;

### U.S. Patent Application Publication No. 2015/0134470;

### U.S. Patent Application Publication No. 2015/0136851;

### U.S. Patent Application Publication No. 2015/0136854;

### U.S. Patent Application Publication No. 2015/0142492;

### U.S. Patent Application Publication No. 2015/0144692;

### U.S. Patent Application Publication No. 2015/0144698;

### U.S. Patent Application Publication No. 2015/0144701;

### U.S. Patent Application Publication No. 2015/0149946;

### U.S. Patent Application Publication No. 2015/0161429;

### U.S. Patent Application Publication No. 2015/0169925;

### U.S. Patent Application Publication No. 2015/0169929;

### U.S. Patent Application Publication No. 2015/0178523;

### U.S. Patent Application Publication No. 2015/0178534;

### U.S. Patent Application Publication No. 2015/0178535;

### U.S. Patent Application Publication No. 2015/0178536;

### U.S. Patent Application Publication No. 2015/0178537;

### U.S. Patent Application Publication No. 2015/0181093;

### U.S. Patent Application Publication No. 2015/0181109;

U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);

U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);

U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER′S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER′S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A print media holder device, comprising:
a first grip member;
at least one permanent magnet attached to the first grip member;
a second grip member;
at least one permanent magnet attached to the second grip member;
the print media holder device having an outer dimension that is defined as a distance from an outermost portion of the first grip member to an outermost portion of the second grip member; and
an electromagnet disposed between the first and second grip members, where when the electromagnet is selectively energized the permanent magnets attached to the first and second grip members are attracted in a manner that reduces the outer dimension of the print media holder device.

2. The device according to claim 1, where the first grip member terminates at an outermost point with one or more grip edges that are configured to grip the media core.

3. The device according to claim 2, where the second grip member terminates at an outermost point with one or more grip edges that are configured to grip the media core.

4. The device according to claim 1, where the electromagnet is selectively energized with a specified current to establish a specified attractive force.

5. The device according to claim 1, where the print media holder device resides within a printer.

6. A print media holder device, comprising:
a first grip member having a first grip edge;
a first grip member magnet attached to the first grip member;
a second grip member having a second grip edge;
the print media holder device having an outer dimension that is defined as a distance from an outermost portion of the first grip member's grip edge to an outermost portion of the second grip member's grip edge; and
a second magnet disposed between the first and second grip edges;
where at least one of the second magnet and the grip member magnet comprises an electromagnet that is selectively energized in a manner that generates attractive forces between the grip member magnet and the second magnet such that the first and second grip edges are pushed inward by magnetic force in a manner that reduces the outer dimension of the print media holder device.

7. The device according to claim 6, where the first grip member magnet comprises a permanent magnet, and where the second magnet comprises an electromagnet.

8. The device according to claim 6, where the first grip member magnet comprises an electromagnet, and where the second magnet comprises a permanent magnet.

9. The device according to claim 6, further comprising a second grip member magnet attached to the second grip member.

10. The device according to claim 9, where the first and second grip member magnets comprise a permanent magnet, and where the second magnet comprises an electromagnet.

11. The device according to claim 9, where the first and second grip member magnets comprise an electromagnet, and where the second magnet comprises a permanent magnet.

12. The device according to claim 6, where the electromagnet is selectively energized with a specified current to establish a specified attractive force.

13. The device according to claim 6, where the print media holder device resides within a printer.

14. A print media holder device, comprising:
a plurality of grip members, each having a grip edge;
a plurality of grip member magnets, each attached to one of the grip member;
the print media holder device having an outer diameter that is defined as distance from an outermost portion of a first grip member edge; and
a plurality of central magnets disposed at a central location with respect to the plurality of grip members;
where at least one of the central magnets and the grip member magnets comprises an electromagnet that is selectively energized in a manner that generates repelling or attractive forces between the grip member magnets and the central magnets such that the grip edges are pushed outward or inward by magnetic force in a manner that increases or decreases the outer diameter of the print media holder device to grip a media core.

15. The device according to claim 14, where the grip member magnets comprise permanent magnets, and where the central magnets comprise electromagnets.

16. The device according to claim 14, where the grip member magnets comprise electromagnets, and where the central magnets comprise permanent magnets.

17. The device according to claim 14, where the electromagnet is selectively energized with a specified current to establish a specified repelling or attractive force.

18. The device according to claim 14, where the print media holder device resides within a printer.
